(19) United States
(12) Patent Application Publication
(10) Pub. No.: US 2008/0285494 A1
(43) Pub. Date: Nov. 20, 2008

(54) Mobile station designed to skip sensitivity measurement of neighboring cell when specific condition is satisfied and power management process thereof

(75) Inventor: Sang-Min Shin, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/906,931

(22) Filed: Oct. 4, 2007

(30) Foreign Application Priority Data
May 16, 2007 (KR) 2007-0047581

(51) Int. Cl. G08C 17/00

(52) U.S. Cl. 370/311

(57) ABSTRACT

A mobile station designed to skip sensitivity measuring of neighboring cells when a specific condition is satisfied and a power management process thereof. The mobile station checks a movement of the mobile station during a reference time T using a motion sensor; and if the movement of the mobile station is not detected during the reference time T, enters an enhanced mode and skipping at least one procedure selected from the group consisting of a procedure of measuring sensitivities of neighboring cells, a procedure of re-selecting a cell and a procedure of tuning with the neighboring cells. This can reduce power consumption in the mobile station, which is fixed for a long time. The power management process can be applied to various types communication systems such as GSM, GPRS, CDMA, WCDMA, HSDPA, HSUPA and TDS-CDMA, in which cell re-selection is carried out.

### CLAIM OF PRIORITY

This application makes reference to and claims all benefits accruing under 35 U.S.C. §119 from an application for “Mobile Station Designed To Skip Sensitivity Measurement Of Neighboring Cell When Specific Condition Is Satisfied And Power Management Process Thereof” earlier filed in the Korean Intellectual Property Office on May 16, 2007 and there duly assigned Serial No. 2007-0047581, the entire contents of which are hereby incorporated by reference herein.

### BACKGROUND OF THE INVENTION

1. Field of the Invention

The present invention relates to a mobile station designed to skip sensitivity measuring of neighboring cells when a specific condition is satisfied and a power management process thereof.

2. Description of the Related Art

In a mobile station, power is consumed by several factors, particularly, by sleep current, digital parts and radio frequency parts.

Of the aforementioned factors, the mobile station consumes sleep current in order to power an oscillator, a Liquid Crystal Display (LCD), a microprocessor and so on while the mobile station is not receiving a message.

In an idle state consuming sleep current, the mobile station can adopt a Discontinuous Reception (DRX) scheme. According to the DRX scheme, the mobile station calculates one or more paging channels of its own and, if it fails to detect its own paging, slows down to lower the clock of its own processor. With a power management process as above, the mobile station can reduce battery power consumption.

FIG. 1 illustrates a flowchart of a sleep mode process of a common mobile station according to the Global System for Mobile communication (GSM) (hereinafter referred to as ‘GSM mobile station’).

Referring to FIG. 1, at step S101 the GSM mobile station maintains a sleep mode when a call establishment for telecommunication with a counterpart station is not enabled. The GSM mobile station in the sleep mode measures the sensitivity (or signal intensity) of serving and neighboring cells in view of the quality of received signals (or channel quality) at step S102.

Upon the measurement of the sensitivity of the serving and neighboring cells at step S102, the GSM mobile station judges whether or not a neighboring cell having a sensitivity the same as or larger than a reference value is detected at step S103. The sensitivity of the serving cell is generally used as the reference sensitivity value. Priority values are considered for specific cells, and specific hysteresis values are considered in a case where a neighboring cell is in a wrong location area. Of course, a network operator can select a different value in order to prevent a situation that cells are frequently re-selected according to the reference sensitivity value. That is, if the sensitivity of a neighboring cell is sufficiently larger than the sensitivity of a currently serving cell even in view of the priority and the hysteresis of the serving cell, a procedure of cell re-selection is carried out. For this purpose, the GSM mobile station repeatedly measures sensitivities of neighboring cells, calculates the value of the measured sensitivities and tunes based upon the calculated values. However, in doing so the GSM mobile station consumes a large amount of battery power. This process of setting the reference sensitivity does not belong to the scope of the present invention and thus will not be described in detail.

If a neighboring cell, which has a sensitivity the same as or larger than the reference sensitivity, is detected at step S103, the GSM mobile station re-selects the neighboring cell detected at step S103 to camp on the re-selected neighboring cell at step S104.

The procedures of steps S101 to S104 are given to simplify a cell re-selection procedure that the GSM mobile station does in the sleep mode. Other mobile stations designed for a Code Division Multiple Access (CDMA) network and so on are also specified to perform a similar cell re-selection procedure.

According to a general sleep mode as shown in FIG. 1 and explained above, a mobile station must periodically wake up to tune in to a paging channel allocated thereto and carry out calculations for cell measurement and cell re-selection.

This, however, requires a microprocessor of the mobile station to operate normally as well as an oscillator to be activated for signal reception and measurement. Accordingly, a considerable amount of power is supplied to the microprocessor and the oscillator, and the effect of the sleep mode to reduce battery power consumption is inevitably degraded.

### SUMMARY OF THE INVENTION

The present invention provides a mobile station, which is designed to enter an enhanced sleep mode from a sleep mode, if a movement of the mobile station is not detected for a reference time and the sensitivity of a radio frequency signal received from a serving cell is the same as or larger than a reference value, and to skip a procedure of cell re-selection, thereby reducing power consumption, and a power management process of the same mobile station.

According to an exemplary embodiment of the invention, a power management process of a mobile station is provided, comprising: at the mobile station, checking a movement of the mobile station for a reference time using a motion sensor; and if the mobile station does not move during the reference time, entering an enhanced mode and skipping at least one procedure selected from the group consisting of a procedure of measuring sensitivities of neighboring cells, a procedure of re-selecting a cell and a procedure of tuning with the neighboring cells.

Preferably, the mobile station is able to access at least one type of network for performing cell re-selection in a sleep mode, said at least one type of network being selected from the group consisting of GSM, General Packet Radio Service (GPRS), CDMA, Wideband CDMA (WCDMA), High Speed Downlink Packet Access (HSDPA), High Speed Uplink Packet Access (HSUPA) and Time Division Switching (TDS) CDMA.

Preferably, the power management process may further include, at the mobile station, checking a sensitivity of a radio frequency signal received from a currently serving cell; and if the sensitivity of the radio frequency signal received from the currently serving cell is less than a reference value, maintaining a general sleep mode. Furthermore, the power management process may further include, at the mobile station, in the enhanced sleep mode, checking a movement of the mobile station using the motion sensor; and if the movement of the mobile station is detected, returning to a general sleep mode.

Preferably, in the step of checking a movement of the mobile station, the motion sensor may check an impact applied to the mobile station. Furthermore, in the procedure of cell re-selection, the mobile station may measure a sensitivity of a radio frequency signal received from a serving or neighboring cell and calculating an average level of the received radio frequency signal.

According to another exemplary embodiment of the present invention, the present invention provides a mobile station supporting a sleep mode including a cell re-selection controller for measuring a sensitivity of a radio frequency signal received from at least one base station and re-selecting a cell based upon a result of the measurement; and an enhanced sleep mode controller for detecting a movement of the mobile station for a reference time and activating or inactivating the cell re-selection controller based upon a result of the movement detection.

Preferably, the mobile station is able to access at least one type of network for performing cell re-selection in the sleep mode, said at least one type of network being selected from the group consisting of GSM, GPRS, CDMA, WCDMA, HSDPA, HSUPA and TDS CDMA.

Preferably, the cell re-selection controller may include a cell measurement module for measuring sensitivities according to radio frequency signals received from a plurality of base stations using a plurality of channels; and a cell re-selection module for selecting a cell, where the mobile station will camp on, using the sensitivities of the radio frequency signals measured by the cell measurement module. In this case, the cell measurement module and the cell re-selection module may maintain an active state irrespective of a control by the enhanced mode sleep controller when a sensitivity of a radio frequency signal received from a currently serving cell is less than a reference value.

Preferably, the enhanced sleep mode controller may include a motion sensor for detecting the movement of the mobile station, outputting a signal to a reset timer and outputting an activation control signal to the cell re-selection controller when the movement of the mobile station is detected; and a timer for measuring whether or not the reference time has passed and, if the movement of the mobile station is not detected in the reference time, outputting an inactivation control signal to the cell re-selection controller. Here, the motion sensor may detect the movement of the mobile station using an impact applied to the mobile station.

According to another exemplary embodiment of the present invention, the present invention provides a power management process of a GSM mobile station including at a base station, broadcasting a system information message via a Broadcast Control Channel (BCCH); at the GSM mobile station, in a sleep mode, measuring a sensitivity of the BCCH and re-selecting a cell based upon the measured sensitivity of the BCCH; at the GSM mobile station, checking a movement of the GSM mobile station for a reference time using a motion sensor; and if the movement of the GSM mobile station is not detected in the reference time, entering an enhanced sleep mode and skipping at least one procedure selected from the group consisting of the procedure of measuring the sensitivity of the BCCH, the procedure of re-selecting a cell and a procedure of tuning with a neighboring cell.

Preferably, in the step of checking a movement of the GSM mobile station, the motion sensor may check an impact applied to the GSM mobile station.

Preferably, the GSM mobile station may enter the enhanced sleep mode when the movement of the GSM mobile station is not detected and a sensitivity of a radio frequency signal received from a currently serving cell is equal to or larger than a reference value.

According to yet another exemplary embodiment of the present invention, the invention provides a power management process of WCDMA dual station, comprising: at the WCDMA dual station, sorting cells according to GSM and UMTS services, ranking the sorted cells according to sensitivities and selecting one of the sorted cells from a default network, the selected cell affording a best connection environment; at the WCDMA dual station, checking a movement of the WCDMA mobile station for a reference time using a motion sensor; and if the movement of the WCDMA dual station is not detected during the reference time, entering an enhanced sleep mode and skipping at least one procedure selected from the group consisting of a procedure of measuring sensitivities of radio frequency signals received from cells for GSM and WCDMA networks, a procedure of re-selecting a cell a procedure of tuning with a neighboring cell.

Preferably, in the step of checking a movement of the WCDMA dual station, the motion sensor may check an impact applied to the WCDMA dual station. Furthermore, the WCDMA dual station may enter the enhanced sleep mode when the movement of the WCDMA dual station is not detected and a sensitivity of a radio frequency signal received from a currently serving cell is equal to or larger than a reference value.

### BRIEF DESCRIPTION OF THE DRAWINGS

The above and other features and advantages of the present invention will be more clearly understood from the following detailed description taken in conjunction with the accompanying drawings, in which:

FIG. 1 is a flowchart illustrating a sleep mode process of a conventional GSM mobile station;

FIG. 2 is a flowchart illustrating a power management process of a mobile station according to an embodiment of the invention;

FIG. 3 is a block diagram illustrating the structure of a mobile station supporting an enhanced sleep mode according to another embodiment of the invention;

FIG. 4 is a conceptual view illustrating the architecture of a GSM network to which the enhanced sleep mode of the invention is applicable;

FIG. 5 is a flowchart illustrating a power management process of the mobile station according to the another embodiment of the invention;

FIG. 6 is a block diagram illustrating the architecture of a UMTS to which the enhanced sleep mode of the invention is applicable; and

FIGS. 7A and 7B are a flowchart illustrating a power management process of a WCDMA dual station according to further another embodiment of the invention.

### DETAILED DESCRIPTION OF THE EMBODIMENTS

The following detailed description will present a mobile station, which is designed to skip a cell re-selection procedure in a sleep mode, and a power management process thereof according to the present invention with reference to the accompanying drawings.

The characteristic features of a mobile station, which can skip a cell re-selection procedure, will be discussed first. For example, several situations might be assumed. That is, a mobile station user might be sleeping; working at the office; and listening to music. In the above assumed situations, the mobile station is fixed to a single location and maintains an idle state.

In the idle state, the mobile station repeatedly performs cell measurements for neighboring cells and calculations for cell re-selection. Of course, the mobile station also carries out these procedures while it is moving in order to provide best telecommunication quality and service.

As explained above, in a situation where a serving cell location is not changed for a long time, for example, due to the user sleeping or working at the office for example and the sensitivity of the serving cell is the same as or larger than a reference value, the mobile station does not greatly need some procedures such as neighboring cell measurement, cell re-selection calculation and tuning with neighboring cells. Accordingly, the present invention has been devised to take advantage of lack of movement of a mobile station.

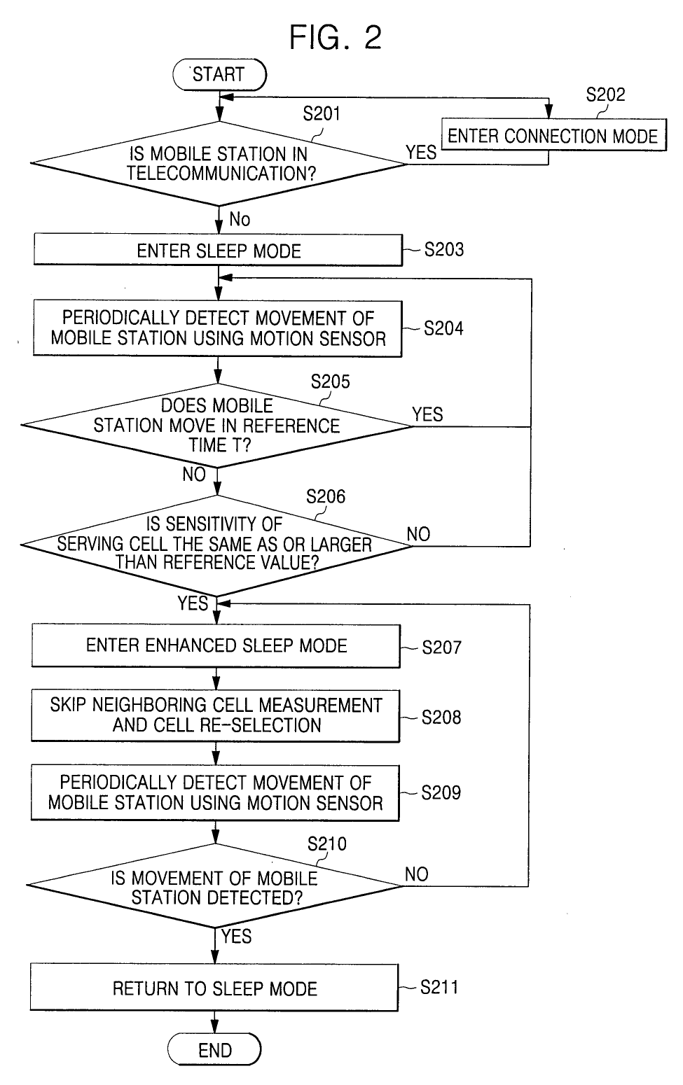

FIG. 2 is a flowchart illustrating a power management process of a mobile station according to an embodiment of the invention.

A mobile station judges whether or not it is in telecommunication with a counterpart station at step S201. If the mobile station is in telecommunication with the counterpart station, the mobile station maintains a connection mode and consumes battery power to carry out telecommunication at step S202.

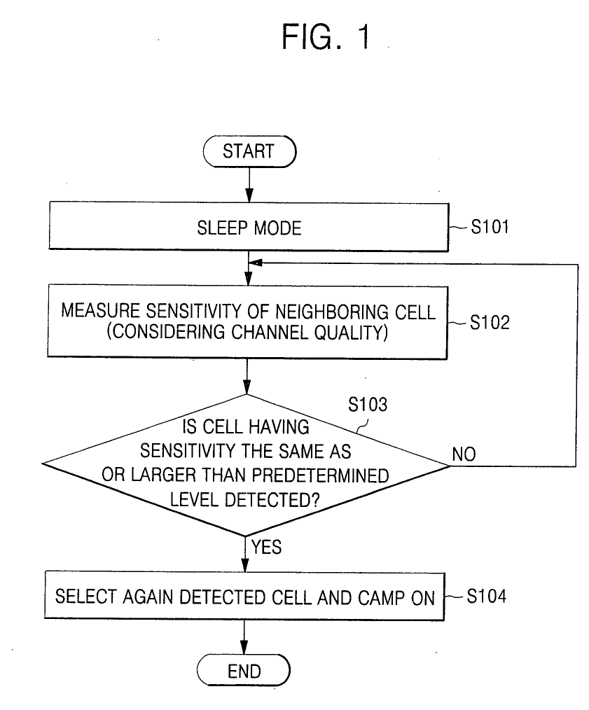

If the mobile station is not in the telecommunication with the counterpart station, the mobile station enters a general sleep mode at step S203. In the general sleep mode, the mobile station measures the sensitivity of serving and neighboring cells and performs a calculation for cell re-selection as explained above with reference to FIG. 1.

After having entered the sleep mode, the mobile station of this embodiment checks a movement of the mobile station using an internal motion sensor in S204.

The motion sensor can detect the movement of the mobile station, using an impact applied to the mobile station. In the case of attempting to detect the movement of the mobile station based upon the impact applied to the mobile station, an impact sensor can be used as the motion sensor. As an alternative, the movement of the mobile station can be detected using a camera sensor or the Global Positioning System (GPS) in place of the impact sensor. However, it should be construed that the use of the GPS may rather increase battery consumption of the mobile station.

The mobile station, which is entering the sleep mode, measures the movement of the mobile station using the motion sensor and judges whether or not the mobile station moves during a reference time T at step S205. If the mobile station moves during the reference time T, the mobile station maintains a general sleep mode and thus returns to step S204.

At step S206, in order for the mobile station to enter an enhanced sleep mode, an additional condition is considered together with the condition that the mobile station does not move for the reference time T. The additional condition is that the sensitivity of a Radio Frequency (RF) signal, which the mobile station receives from a currently connected base station, is the same as or larger than a reference value S. Although the mobile station does not move, if the mobile station receives a weak signal, it is more preferable to carry out cell re-selection.

If the mobile station in the sleep mode does not move for the reference time T and the sensitivity of RF signal received from the serving cell is the same as or larger than the reference value, the mobile station enters the enhanced sleep mode in S207.

In the enhanced sleep mode, the mobile station skips several procedures at step S208. That is, the mobile station skips measuring the intensity of RF signals received from the neighboring cells, calculating a Received Level Average (i.e., the level average of the received RF signals) and tuning with the neighboring cells.

Even in the enhanced sleep mode, the mobile station repeatedly detects a movement of the mobile station using the motion sensor at step S209. If the motion sensor detects the movement of the mobile station, the mobile station immediately returns to the general sleep mode in S210.

The enhanced sleep mode is substantially the same as the general sleep mode, but skips sensitivity measurement of RF signals from neighboring cells, calculation for cell re-selection based upon measurement and tuning with the neighboring cells.

After having returned to the general sleep mode, the mobile station measures the sensitivity of serving and neighboring cells, calculates an average received level and re-selects a cell in response to a movement thereof.

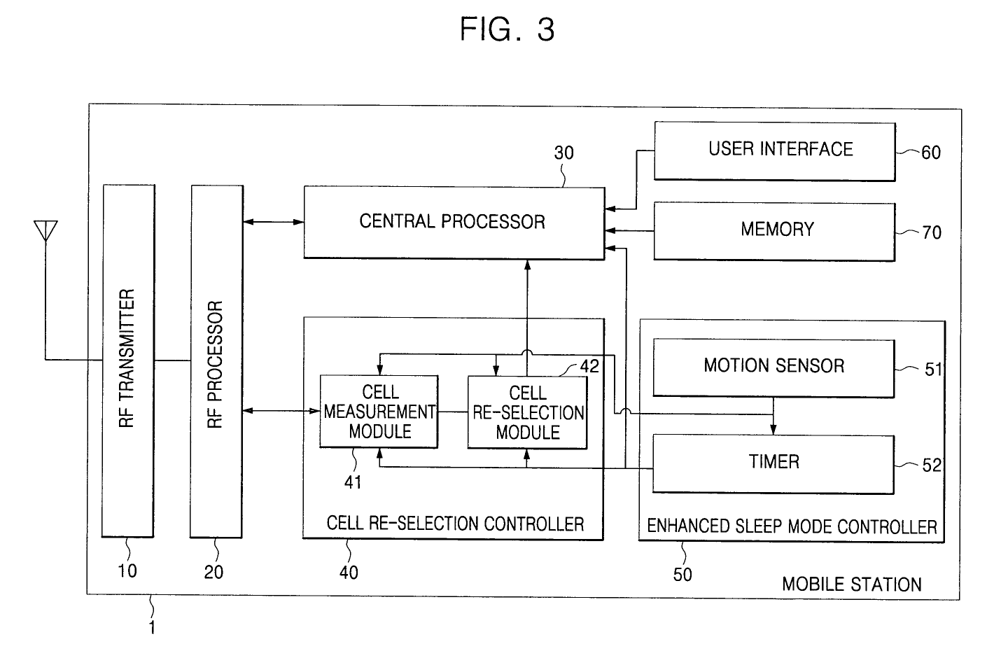

According to the enhanced sleep mode of the mobile station shown in FIG. 2, the mobile station skips several procedures in the sleep mode such as sensitivity measurement of neighboring cells, calculation for cell re-selection and tuning with the neighboring cells. Accordingly, this allows the mobile station to consume less battery power. FIG. 3 is a block diagram illustrating the structure of a mobile station 1 supporting an enhanced sleep mode according to another embodiment of the invention.

As shown in FIG. 3, the mobile station 1 includes a Radio Frequency (RF) transmitter 10, an RF processor 20, a central processor 30, a cell re-election controller 40, an enhanced sleep mode controller 50, a user interface 60, a memory 70 and so on.

The RF transceiver 10 acts to receive radio frequency signals, transmitted/received in a specific radio frequency channel, using an antenna. The RF processor 20 down-converts an RF signal, received by the RF transceiver 10, and delivers a down-converted frame to the central processor 30. On the other hand, the RF processor 20 up-converts a frame, delivered from the central processor 30, and delivers the up-converted frame to the RF transceiver 10.

The central processor 30 is a component, which has an overall control over the mobile station 1 as well as processes data, which are received from the RF processor 20, and outputs the processed data to the user interface 60. Upon receiving data from the user interface, the central processor 30 also executes a control to transmit the data to a core network or a counterpart station via the RF processor 10 and the RF transceiver 20.

As characteristic features of this embodiment, the mobile station includes the cell re-selection controller 40 and the enhanced sleep mode controller 50. The function of these components for enabling the enhanced sleep mode is explained as follows:

Referring to FIG. 3, the cell re-selection controller 40 includes a cell measurement module 41 and a cell re-selection module 42 and is constituted separately from the central processor 30. Of course, those skilled in the art can simplify the constitution by incorporating the cell re-selection controller 40 into the central processor 30 and so on. The configuration shown in FIG. 3 is by way of example only.

The cell measurement module 41 of the cell re-selection controller 40 functions to measure the sensitivity of an RF signal, which is received by the RF transceiver 10. The RF transceiver 10 receives RF signals from a plurality of base stations using a plurality of channels, and the cell measurement module 41 measures the sensitivity of the RF signals of a respective channel.

The cell re-selection module 42 serves to select a base station, which the mobile station 1 will camp on, using the sensitivity of the RF signal measured by the cell measurement module 41. For example, in a case where the mobile station is receiving RF signals from a first base station, if a second base station is sending RF signals stronger than those of the first base station, the mobile station 1 preferably selects the second base station. In this fashion, the cell re-selection module 42 selects a base station according to the strength of the RF signals.

The enhanced sleep mode controller 50 executes a control to activate or inactivate the cell re-selection controller 40, which includes the cell measurement module 41 and the cell re-selection module 42.

During the sleep mode operation of the mobile station, the enhanced sleep mode controller 50 inactivates the cell re-selection controller 40 if the mobile station 1 does not move during the reference time T. Here, even though the cell re-selection controller 40 is inactivated, sensitivity measurement is still enabled for a serving cell rather than for neighboring cells. For this purpose, the enhanced sleep mode controller 50 includes a motion sensor 51 and a timer 52.

The motion sensor 51 is a device to measure or detect a movement of the mobile station 1. The present invention provides an approach to measure the movement of the mobile station using an impact that is applied to the mobile station. Of course, it is apparent that any methods capable of detecting the movement of the mobile station can be applied to the present invention. The impact approach is by way of example only.

The motion detection sensor 51 periodically detects the movement of the mobile station 1 and, in the case of detecting the movement of the mobile station 1, delivers a reset signal to the timer 52.

The timer 52 is a component for measuring whether or not the reference time T has passed. If the reference time T has passed, the timer 52 outputs an inactivation control signal to its subordinate components such as the cell measurement module 41 and the cell re-selection module 42.

On the other hand, the enhanced sleep mode controller 52 detects the movement of the mobile station 1 even after the inactivation control signal is outputted. If the movement of the mobile station 1 is detected, an activation control signal is applied to the cell measurement module 41 and the cell re-selection module 42.

In brief, in a condition that the mobile station 1 should not move during the reference time T, the enhanced sleep mode controller 50 executes a control to inactivate the operation of the cell measurement module 41 and the cell re-selection module 42.

In order to enter the enhanced sleep mode, the mobile station 1 of the invention can consider a condition that the sensitivity of RF signals received from a currently connected base station is the same as or larger than the reference value in addition to the condition that any movement is not detected during the reference time T. Even though the mobile station 1 has no movement, if the mobile station 1 receives weak signals, it is more preferable to carry out cell re-selection.

For this purpose, even though an inactivation control signal is received from the timer 52, the cell measurement module 41 and the cell re-selection module 42 of the cell re-selection controller 40 act normally in the case of receiving RF signals, which have a sensitivity the same as or greater than the reference value S.

The power management process as explained above can be applied to various fields such as GSM, General Packet Radio Service (GPRS), Code Division Multiple Access (CDMA), Wideband CDMA (WCDMA), High Speed Downlink Packet Access (HSDPA), High Speed Uplink Packet Access (HSUPA), Time Division Switching (TDS) CDMA, where various types of mobile stations can be used to measure the sensitivity of signals received from serving and neighboring cells for the purpose of cell re-selection.

The mobile station 1 can further include the user interface 60. The user interface includes a key input (not shown), an audio output (not shown), a video output (not shown) and so on.

The mobile station 1 displays a menu, which is used for setting environments of the enhanced sleep mode, via the user interface 60. It is also possible for a user to input the environments of the enhanced sleep mode.

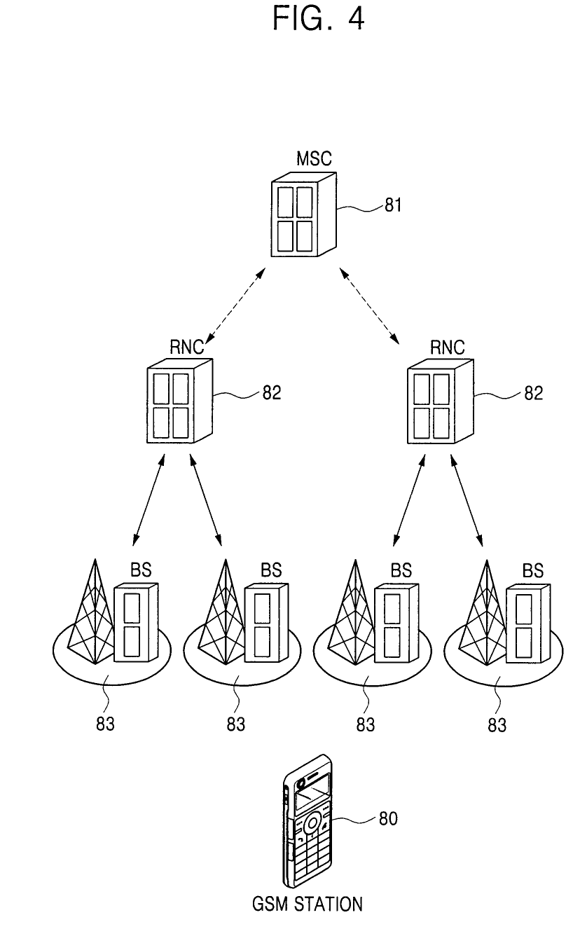

FIG. 4 is a conceptual view illustrating the architecture of a GSM network to which the enhanced sleep mode of the invention is applicable.

As shown in FIG. 4, the GSM network includes a Mobile Service Switching Center (MSC) 81 located in a core network, base stations 83 each existing in a respective radio access network (RAN) and Radio Network Controllers (RNCs) 82.

In the GSM network, a respective base station 83 transmits a signal on a broadcasting control channel (BCCH) having a different frequency from a neighboring base station 83. The GSM mobile station 80 measures the reception sensitivity of a BCCH and, based upon the result of the measurement, determines which cell is most effective in terms of radio connection quality.

In a respective cell, the GSM mobile station 80 receives information about how to make an access request to a specific cell in order to establish a connection. In particular, the GSM mobile station 80 receives BCCH frequency information, which the base station of a neighboring cell is using, from the base station of a serving cell.

After the GSM mobile station 80 acquires the BCCH frequencies of the serving and neighboring cells, the GSM mobile station 80 periodically searches for a neighboring cell, which provides higher signal quality than a currently connected base station 83. The GSM mobile station 80 executes a measurement for searching a cell having the best pilot and a cell re-selection calculation according to cell re-selection conditions.

If there is no movement during the reference time T in the sleep mode and the sensitivity of RF signals, received from the currently connected base station 83, is the same as or larger than the reference value, the GSM mobile station 80 of the invention enters the enhanced sleep mode.

After the GSM mobile station 80 enters the enhanced sleep mode, the GSM mobile station 80 skips a procedure of re-selecting a cell corresponding to a respective base station 83.

Herein, the internal structure of the GSM mobile station, to which the enhanced sleep mode is applied, can be sufficiently understood from the internal structure of the mobile station as illustrated in FIG. 3 and from the power management process by the GSM system as illustrated in FIG. 4. Therefore, detailed description of the GSM mobile station structure is omitted.

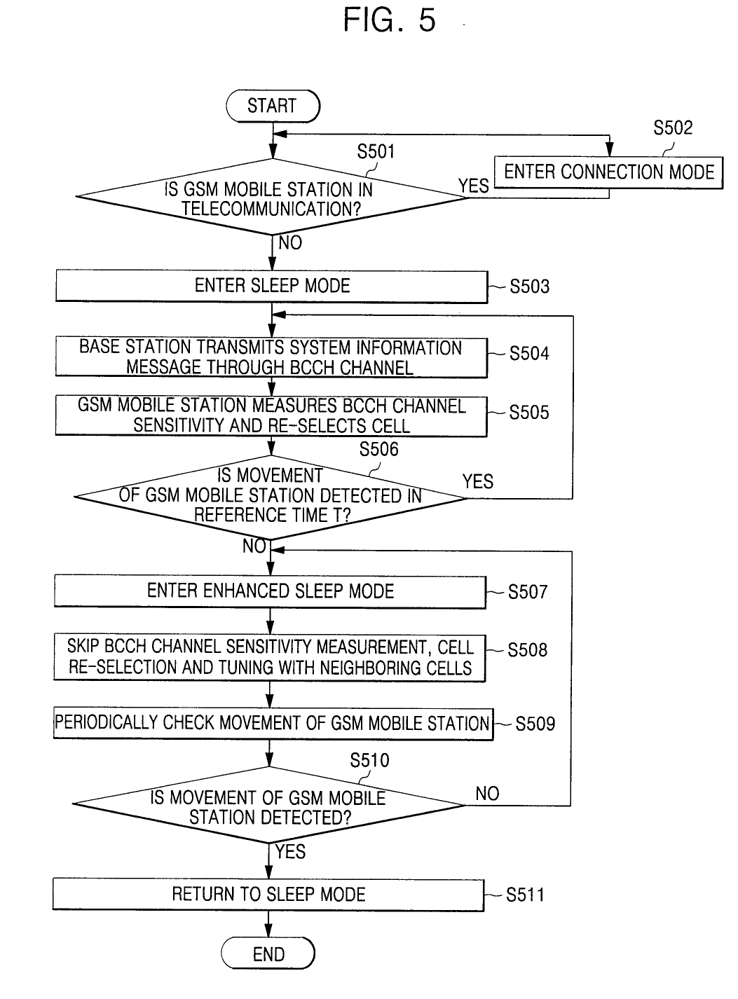

FIG. 5 is a flowchart illustrating a power management process of the mobile station according to another embodiment of the present invention.

At step S501, the GSM mobile station 80 judges whether or not it is participating in a telecommunication. If the GSM mobile station 80 is participating in a telecommunication with a counterpart mobile station, the GSM mobile station 80 operates in a connection mode at step S502. Otherwise, the GSM mobile station 80 enters a general sleep mode at step S503.

Even if the GSM mobile station 80 enters the sleep mode, the base station broadcasts a system information message through a BCCH at step S504. The GSM mobile station 80 periodically measures the sensitivity of the BCCH according to serving and neighboring cells and re-selects a cell according to measured values at step S505. In greater detail, the GSM mobile station 80 executes a measurement for re-selecting a cell, which can afford the best service, and determines whether or not to re-select the cell based upon cell re-selection conditions.

At step S506, the GSM mobile station checks the movement of the GSM mobile station during the reference time T, using the motion sensor. If the GSM mobile station does not move during the reference time T and the sensitivity of RF signals, received from the serving cell, is the same as or larger than the reference value, the GSM mobile station enters an enhanced sleep mode in S507.

Of course, as illustrated above with reference to FIGS. 2 to 4, the GSM mobile station can further check whether or not the sensitivity of signals, received through the BCCH according to the currently connected base station, is the same as or larger than a preset value.

Then, in S508, the GSM mobile station skips some procedures, which include a sensitivity measurement of signals received through the BCCH and a calculation for cell re-selection as in S505 and a procedure of tuning with neighboring cells. In the enhanced sleep mode, of course, if a call origination request is inputted from the user, the GSM mobile station can wake up and enter a normal mode.

The GSM mobile station in the enhanced sleep mode repeatedly checks a movement thereof using a motion sensor at step S509. If a movement of the GSM mobile station is detected as a result of step S509, the GSM mobile station conducts a control to return to the general sleep mode in S511. After the GSM mobile station returns to the general sleep mode, the GSM mobile station measures the sensitivity of received signals according to the BCCH and performs a calculation for cell re-selection.

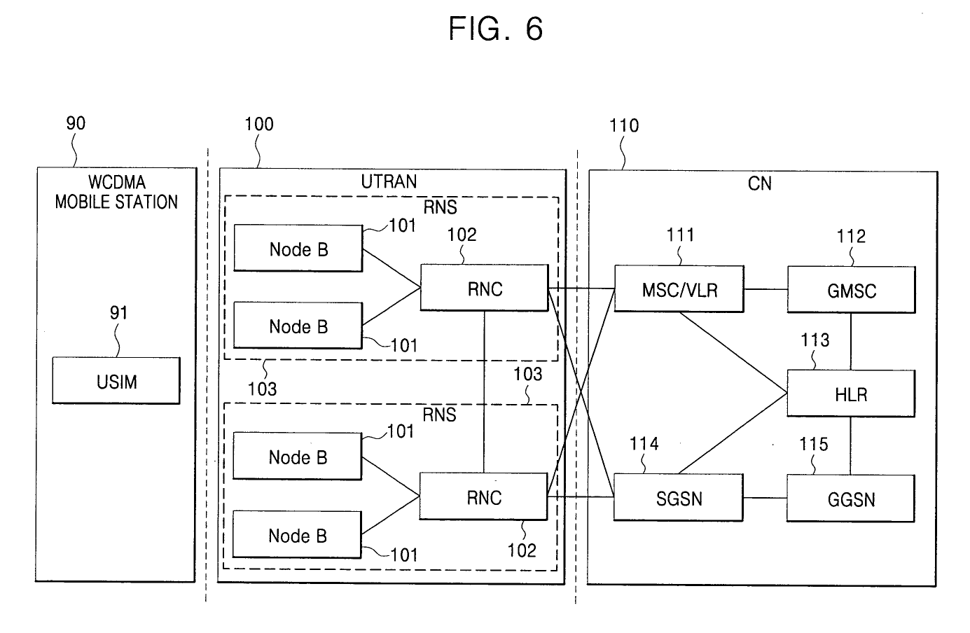

FIG. 6 is a block diagram illustrating the architecture of a UMTS to which the enhanced sleep mode of the present invention is applicable.

Referring to FIG. 6, a Universal Mobile Telecommunications System (UMTS) includes a Wideband CDMA (WCDMA) mobile station 90, a UMTS Terrestrial RAN (UTRAN) 100 and a core network 110.

First, the WCDMA mobile station 90 provides services to users using a WCDMA interface, and includes a UMTS Subscriber Identity Module (USIM) 91, which stores authentication and encryption keys and subscription data.

The UTRAN 100 establishes and maintains a radio access barrier for a telecommunication between the WDCMA mobile station 90 and the core network 110, and can include at least one Radio Network Subsystem (RNS) 103.

The RNS 103 includes a Radio Network Controller (RNC) 102 and at least one node 101 (Node B). The RNC 102 acts to allocate and manage radio resources and the node 101 acts to transmit/receive data to/from the WCDMA mobile station via up and down links.

In particular, the UTRAN 100 broadcasts a system information message to the WCDMA mobile station 90, in an idle state or in a connection mode, via the RNC 102 and the node 101, in which the WCDMA mobile station 90 exists in the cell.

In the UMTS, the system information message can be delivered through a BCCH, which is mapped by a Broadcast Channel (BCH) or a Forward Access Channel (FACH).

The WCDMA mobile station 90 updates a cell by receiving a System Information Block 3 (SIB 3) message, which is one type of system information message. In greater detail, the WCDMA mobile station 90 re-selects a cell using cell ID information of the SIB 3 message. After the WCDMA mobile station 90 re-selects the cell, it sends a cell update message to the UTRAN 100 in order to report that the cell is updated. As a response, the UTRRAN 10 transmits a cell update acknowledgment message to the WCDMA mobile station 90.

The enhanced sleep mode of the invention can be applied to the UMTS, which performs a cell re-selection process in an idle state. The following description presents a power management process of a mobile station in the UMTS.

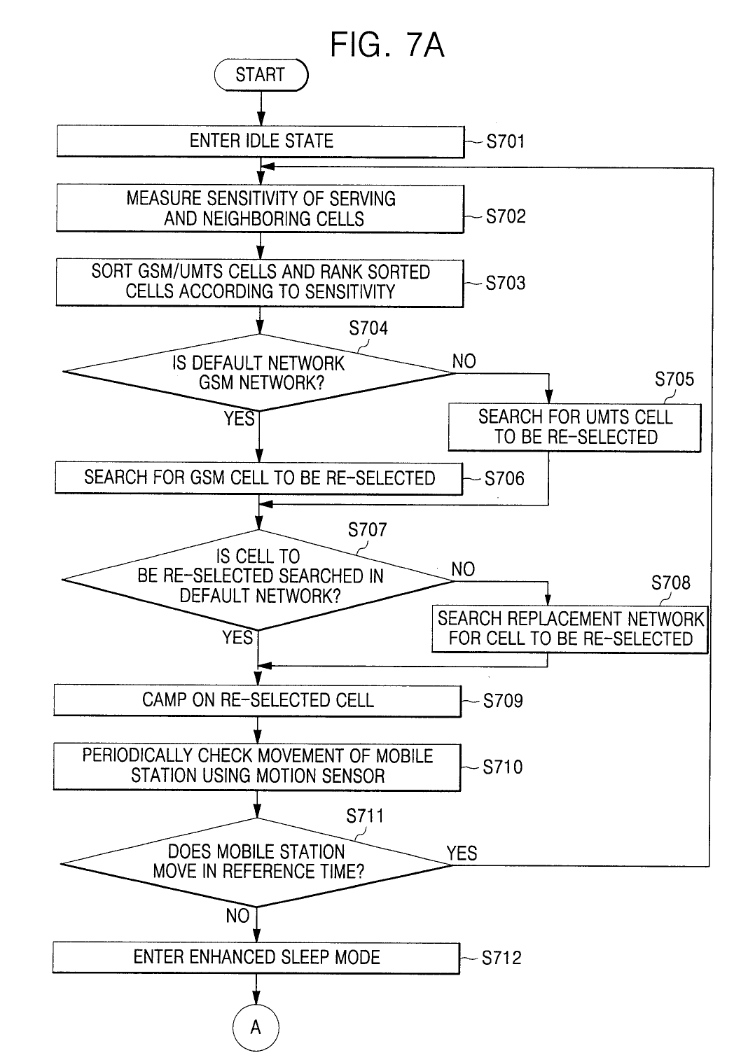

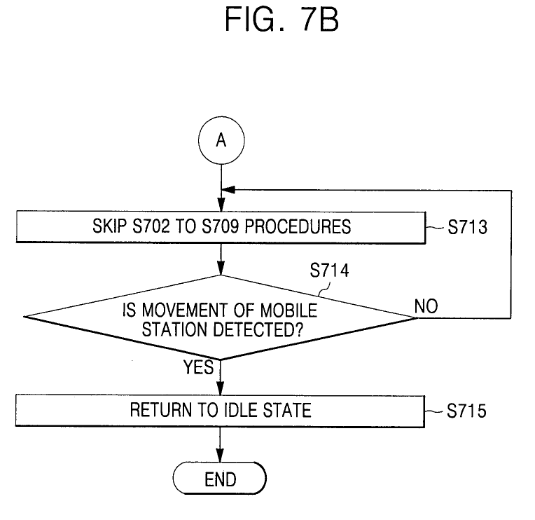

FIGS. 7A and 7B are a flowchart illustrating a power management process of a WCDMA dual station according to another exemplary embodiment of the present invention.

The WCDMA dual station refers to a station, which can provide a service using the UTMS as shown in FIG. 6 as well as a service using the GSM. With reference to FIGS. 7A and 7B, it will be described that the power management process using an enhanced sleep mode can be applied to the dual station.

At step S701, the WCDMA dual station enters a general sleep mode in an idle state. When the WCMDA dual station enters the sleep mode, it receives system information messages such as SIB 2 and 3 from Node B through a BCH or BCCH.

The WCDMA dual station measures the sensitivity of RF signals received from serving and neighboring cells in S702.

At step S703, the WCDMA dual station sorts cells according to GSM and UTMS services and ranks the sorted cells according to sensitivity.

Then, the WCDMA dual station checks whether or not its own default network is a GSM network at step S704. In this case, the default network can be selected manually by a user according to his/her favorite or automatically by the WCDMA dual station according to various environmental factors.

At steps S705 and S706, the WCDMA dual station searches a list, which is sorted as the default network in S704, to find a cell to be re-selected. For example, if the default network is the GSM network, the WCDMA dual station searches for a GSM cell having a largest sensitivity in S706.

In this case, the cell to be re-selected may not be found at step S707. That is, the largest cell sensitivity may be smaller than a reference value or no cell may exist for the default network. In this case, the WCDMA dual station searches a replacement network list for a cell to be re-selected in S708.

At step S710, the WCDMA dual station of the invention checks a movement of the station during a reference time T, using a motion sensor in S710.

If the WCDMA mobile station moves during the reference time T, the WCDMA dual station enters an enhanced sleep mode in S712. In S713, the WCDMA dual station skips procedures of S702 to S709.

The WCDMA dual station repeatedly checks the movement of the station using the motion sensor at step S714. If the movement of the WCDMA dual station is detected as a result of step S714, the WCDMA dual station returns to the idle state in S715.

According to the present invention as set forth above, the mobile station can enter an enhanced sleep mode from a sleep mode, if a movement of the mobile station is not detected for a reference time and the sensitivity of a radio frequency signal received from a serving cell is the same as or larger than a reference value, and skip a procedure of cell re-selection, thereby reducing power consumption. Furthermore, the mobile station performing the power management process of the invention can be applied to various types of communication systems such as GSM, GPRS, CDMA, WCDMA, HSDPA, HSUPA and TDS-CDMA, in which cell re-selection is carried out.

While the present invention has been shown and described in connection with the preferred embodiments, it will be apparent to those skilled in the art that modifications and variations can be made without departing from the spirit and scope of the invention as defined by the appended claims.

What is claimed is:

1. A method of managing power of a mobile station, comprising:
at the mobile station, checking a movement of the mobile station during a reference time using a motion sensor; and
if the movement of the mobile station is not detected in the reference time, entering an enhanced mode and skipping at least one procedure selected from the group consisting of a procedure of measuring sensitivities of neighboring cells, a procedure of re-selecting a cell and a procedure of tuning with the neighboring cells.

2. The method according to claim 1, wherein the mobile station is able to access at least one network for performing cell re-selection in a sleep mode, selected from the group consisting of Global System for Mobile communication (GSM), General Packet Radio Service (GPRS), Code Division Multiple Access (CDMA), Wideband CDMA (WCDMA), High Speed Downlink Packet Access (HSDPA), High Speed Uplink Packet Access (HSUPA) and Time Division Switching (TDS) CDMA.

3. The method according to claim 1, further comprising:
at the mobile station, checking a strength of a radio frequency signal received from a currently serving cell; and
if the sensitivity of the radio frequency signal received from the currently serving cell is less than a reference value, maintaining a general sleep mode.

4. The method according to claim 1, further comprising:
at the mobile station, in the enhanced sleep mode, checking a movement of the mobile station using the motion sensor; and
if the movement of the mobile station is detected, returning to a general sleep mode.

5. The method according to claim 1, wherein the step of checking a movement of the mobile station comprises, at the motion sensor, checking an impact applied to the mobile station.

6. The method according to claim 1, wherein the procedure of cell re-selection comprises the steps of, at the mobile station, measuring a strength of a radio frequency signal received from a serving or neighboring cell and calculating an average level of the received radio frequency signal.

7. A mobile station supporting a sleep mode, comprising:
a cell re-selection controller for measuring a strength of a radio frequency signal received from at least one base station and re-selecting a cell based upon a result of the measurement; and
an enhanced sleep mode controller for detecting a movement of the mobile station during a reference time and activating or inactivating the cell re-selection controller based upon a result of the detecting.

8. The mobile station according to claim 7, wherein the mobile station is able to access at least one network for performing cell re-selection in the sleep mode, said network being selected from the group consisting of Global System for Mobile communication (GSM), General Packet Radio Service (GPRS), Code Division Multiple Access (CDMA), Wideband CDMA (WCDMA), High Speed Downlink Packet Access (HSDPA), High Speed Uplink Packet Access (HSUPA) and Time Division Switching (TDS) CDMA.

9. The mobile station according to claim 7, wherein the cell re-selection controller includes:
a cell measurement module for measuring strength according to radio frequency signals received from a plurality of base stations using a plurality of channels; and
a cell re-selection module for selecting a cell, where the mobile station will camp on, using the strength of the radio frequency signals measured by the cell measurement module.

10. The mobile station according to claim 9, wherein the cell measurement module and the cell re-selection module maintain an active state irrespective of a control by the enhanced mode sleep controller when a strength of a radio frequency signal received from a currently serving cell is less than a reference value.

11. The mobile station according to claim 9, wherein the enhanced sleep mode controller includes:
a motion sensor for detecting the movement of the mobile station and when the movement of the mobile station is detected outputting a signal to a reset timer and an activation control signal to the cell re-selection controller; and
a timer for measuring whether or not the reference time has expired and, if the movement of the mobile station is not detected during the reference time, outputting an inactivation control signal to the cell re-selection controller.

12. The mobile station according to claim 11, wherein the motion sensor detects the movement of the mobile station using an impact applied to the mobile station.

13. A power management process of a GSM (Global System for Mobile communication) mobile station, comprising:
at a base station, broadcasting a system information message via a Broadcast Control Channel (BCCH);
at the GSM mobile station, in a sleep mode, measuring a strength of the BCCH and re-selecting a cell based upon the measured strength of the BCCH;
at the GSM mobile station, checking a movement of the GSM mobile station during a reference time using a motion sensor; and
if the movement of the GSM mobile station is not detected during the reference time, entering an enhanced sleep mode and skipping at least one procedure selected from the group consisting of the procedure of measuring the strength of the BCCH, the procedure of re-selecting a cell and a procedure of tuning with a neighboring cell.

14. The power management process according to claim 13, wherein the step of checking a movement of the GSM mobile station comprises, at the motion sensor, checking an impact applied to the GSM mobile station.

15. The power management process according to claim 13, wherein the GSM mobile station enters the enhanced sleep mode when the movement of the GSM mobile station is not detected and a strength of a radio frequency signal received from a currently serving cell is equal to or larger than a reference value.

16. A power management process of Wideband CDMA (WCDMA) dual station, comprising:
at the WCDMA dual station, sorting cells according to GSM (Global System for Mobile communication) and UMTS (Universal Mobile Telecommunication System) services, ranking the sorted cells according to strength and selecting one of the sorted cells from a default network, the selected cell affording a best connection environment;
at the WCDMA dual station, checking a movement of the WCDMA mobile station during a reference time using a motion sensor; and
if the movement of the WCDMA dual station is not detected during the reference time, entering an enhanced sleep mode and skipping at least one procedure selected from the group consisting of a procedure of measuring strength of radio frequency signals received from cells for GSM and WCDMA networks and a procedure of re-selecting a cell a procedure of tuning with a neighboring cell.

17. The power management process according to claim 16, wherein the step of checking a movement of the WCDMA dual station comprises, at the motion sensor, checking an impact applied to the WCDMA dual station.

18. The power management process according to claim 16, wherein the WCDMA dual station enters the enhanced sleep mode when the movement of the WCDMA dual station is not detected and a strength of a radio frequency signal received from a currently serving cell is equal to or larger than a reference value.
